(19) United States
(12) Patent Application Publication
(10) Pub. No.: US 2005/0278300 A1
(43) Pub. Date: Dec. 15, 2005

(54) Network-Exploiting System for Providing Information on Positions/Help Wanted and Related Information

(75) Inventor: Hirotoshi Kato, Shinjuku-ku, Tokyo (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: PA CO., LTD., Shinjuku-ku, Tokyo (JP)

(21) Appl. No.: 10/908,073

(22) Filed: Apr. 27, 2005

(30) Foreign Application Priority Data
Apr. 28, 2004 (JP) JP-2004-134927

(51) Int. Cl. G06F 17/30

(52) U.S. Cl. 707/2

(57) ABSTRACT

Specialized system exploiting a network by employing an aggregate system to facilitate the provision of positions—/help-wanted and related information. Specialized system includes a plurality of nonspecific sites linked via a network, and a server, connected to the network, for hosting a dedicated site devoted to positions-wanted and help-wanted information. The server reposits dedicated-site interfaces, databases, and control systems. The interfaces carry positions-wanted and help-wanted information, and are open to the network and browsable by stationary and mobile communications devices. Via the databases the control systems constantly update the positions—/help-wanted and other relevant information on, and provide such information to, the interfaces. Meanwhile, the control systems provide to the nonspecific sites display items that are equivalent to the information provided on the dedicated-site interfaces, whereby the interfaces open to the network are made available not only on the server, but also on the nonspecific sites.

### BACKGROUND OF THE INVENTION

1. Technical Field

The present invention relates to systems exploiting the Internet or other networks to provide information on positions/help wanted and other information relevant to such recruiting information.

2. Description of the Related Art

Conventionally, companies have used classified advertisements in publications such as newspapers and job advertisement magazines for recruiting. More recently, companies have set up their own sites on the Internet and have included recruitment information within those sites for job-seekers.

In addition, education-related entities such as high schools, junior colleges, four-year colleges, technical-vocational schools and other training institutions have used classified advertisements in magazines targeted towards education-related companies to provide information to prospective applicants for related certifications. And signboard and advertising on mass media such as TV and radio have been used for providing information for recruiting students. Other companies have set up their own sites on the Internet, and have put advertisements in the sites to provide information about student recruiting.

However, these conventional means for recruiting have the following disadvantages.

Classified advertisements in newspapers reach those who purchase newspapers; therefore, the advertisements do not focus on desired targets. As for classified advertisements in the job advertisement magazines, a job-seeker has to purchase the magazines at a bookstore, or other location to get the information, and thus, the information is not within easy reach. And since only job-seekers purchase these magazines, the information is not available to potential job-seekers who are thinking of improving their careers.

The more recent practice of posting classified advertisements for recruiting on individual company websites does not make the information readily accessible, since there are countless websites and job seekers must trawl for information among the sites; thus, the chances are low that the information will reach job-seekers.

In sum, conventional means for recruiting students have the following disadvantages:

As for classified advertisements in magazines designed for recruiting students, prospective certification applicants have to purchase the magazines at a bookstore or other location to get the information, and thus, the information is not within easy reach. And since only prospective applicants for certification purchase these magazines, the information is not available to potential certification applicants who are thinking of improving their skills.

Classified advertisements on signboards and advertising on mass media such as TV and radio does not focus on the desired targets; therefore, the advertising is less effective despite the high cost.

The more recent practice of posting classified advertisements for recruiting students on company websites does not make the information readily accessible, since there are countless websites and job-seekers must trawl for the information among the sites; thus, the possibility is low that the information will reach prospective certification applicants.

To address the above-mentioned disadvantages, at http://www.jobmail.co.jp/ a system has recently been developed at a specialized site on the Internet, for providing information about recruiting, and a method for accepting applications at the site has been created.

In the system for providing recruiting information at a specialized site, a company's advertisement is posted on the site to provide information about the company's recruiting; job-seekers at the site browse through the company's advertisement so that they can get the necessary information to apply for a position with the company. The company screens application materials and then interviews applicants to decide whether to hire them. Accordingly, the disadvantage of advertisements in newspaper and job advertisement magazines, which must be purchased by job-seekers, is removed, because information about recruiting can be gained wherever and whenever a computer terminal is connected to the Internet. In addition, the specialized site provides a large amount of information about recruiting at a single location, which resolves the problem of trawling for information posted on the websites of countless different companies.

As a means of recruiting students, at http://www.licenseworld.co.jp/ a system for providing students with recruiting information at a specialized site on the Internet was created.

In the system for providing recruiting information to students at the specialized site, an education-related company's advertisement is posted on the site to provide information about student recruiting, and prospective applicants can request a school brochure or complete an application for admission to the school. Accordingly, the disadvantages of advertisements in magazines, which must be purchased by job-seekers, is removed, because information about student recruiting can be gained wherever and whenever a computer terminal is connected to the Internet. In addition, the specialized site provides a large amount of information about student recruiting at a single site, which resolves the problem of trawling for information posted on the websites of different education-related companies.

However, even though the above-mentioned specialized sites for information about job offers and student recruiting have been established, and the information from the sites has been gained, the chances that the sites will be browsed is still low, due to the large numbers of existing sites. Therefore, a small number of applications and registrations for job offerings related to the provided information and a small number of requests for school brochures and applications for admission are expected.

To resolve the problem, an announcement is made using a banner advertisement at a portal site, although such an announcement also has the disadvantage of being advertised only on the site itself.

In addition, in Japanese Unexamined Pat. App. Pub. No. 2003-296602 a system for increasing access to the specialized recruiting sites by using links from other sites has been proposed. In this system, access to the specialized recruiting sites is available via links from various existing sites and homepages. When the access leads to an actual application, the site or homepage linked to the specialized site is rewarded via this link extension system.

The above-mentioned link extension system is a linked system that requires users to move among a plurality of sites or homepages. In Japanese Unexamined Pat. App. Pub. No. 2002-73403 a system that, unlike the link extension system, does not require moving has been proposed, in which the necessary information is provided at one homepage. This system has both a closed site linking companies and an open site linking companies and users. Information entered at one site is transferred automatically to a corresponding page on another site so that the information may be browsed from the other site. Thus, under this system, a plurality of correlated sites may be operated simultaneously. In this system, the information transferred from a closed site to an open site is personal data such as information about job offers and recruiting.

### BRIEF SUMMARY OF THE INVENTION

In the present invention, general affairs companies, placement companies, temporary-employment agencies, and education-related entities such as high schools, junior colleges, four-year colleges, technical-vocational schools, and other training institutions will collectively be referred to as recruiting companies.

Issues to be addressed by the invention are: utilizing networks as a means for recruiting companies to more efficiently conduct job-offering and recruiting activities, and providing, via websites, recruiting, job, and related information to job-seekers and prospective applicants for certifications.

To address the above-mentioned issues, the invention is primarily characterized by setting up a specialized site using a network to provide information about job offers, recruiting, and other information, and to recruit students; the invention is also characterized by setting up featured sections for information about job offers and recruiting, for recruiting students, and for other information in various sites which are often browsed by the individuals targeted to receive the information, that is, job seekers and prospective applicants for certification, so that the information is also provided in various sites and data are collected at the featured sections for a database of information regarding of job seekers and prospective applicants for certification.

The present invention provides the following advantages by setting up web pages as interfaces open to a network not only in the server of the specialized site for recruiting information, but also in a plurality of various other sites: (1) Much more information can be collected than the amount that can be collected solely on the web pages of the specialized site for recruiting information. (2) The frequency of browsing the web pages is higher because the various linked sites also have feature sections that appeal to users. Accordingly, with this general system, (3) recruiting companies can provide information about recruiting to targeted job-seekers and potential job-seekers, and schools can provide information about the application process to targeted prospective applicants for certification. The system also enables the companies to be introduced with greater certainty to personnel they wish to employ, and by the system carrying out notifications in order to secure the necessary number of applications, the likelihood of hiring is raised. Furthermore, by the system making announcements to secure a number of requests for brochures and other materials on a school from persons who wish to enter the school, the likelihood of new entrants to the school is raised. (4) Job-seekers and prospective applicants for certification can gain recruiting and other information by accessing both the server of the specialized site for recruiting information and a number of other sites, and, in the same manner, can apply for employment or request a brochure from the recruiting company whenever they want.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

FIG. 1 is a schematic diagram showing the general system of the invention;

FIG. 2 is an explanatory diagram showing an example of the home page of a specialized site for information about job offers and recruiting;

FIG. 3 is an explanatory diagram showing an example of the “My Page” for a recruiting company that appears after the company logs in at the home page;

FIG. 4 is an explanatory diagram showing an example of the format on the “Edit Recruiting Information Page” that appears after a recruiting company selects the registration button on the company's “My Page”;

FIG. 5 is an explanatory diagram showing an example of the “Detailed Recruiting Information Page” that is displayed on the specialized site for information about job offers and recruiting;

FIG. 6 is an explanatory diagram showing the “My Page” for job-seekers and prospective applicants for certification;

FIGS. 7-11 are explanatory diagrams representing first through fifth sections, respectively, in the flow of a first process that a recruiting company carries out;

FIGS. 12 and 13 are explanatory diagrams representing first and second sections, respectively, in the flow of a second process that a recruiting company carries out; and

FIGS. 14 and 15 are explanatory diagrams representing first and second sections, respectively, in the flow of a third process that a recruiting company carries out.

### DETAILED DESCRIPTION OF THE INVENTION

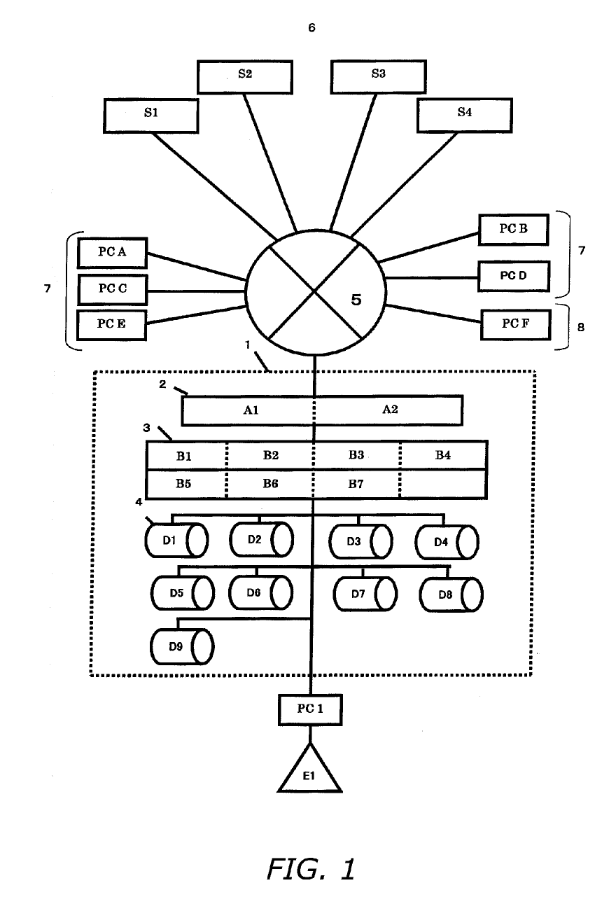

As shown in FIG. 1, the general system of the invention is connected to a network 5, comprising a server 1 for the specialized site for information about job offers and recruiting and various other sites 6 connected to the network 5, in which the server 1 has interfaces 2, control systems 3, and databases 4.

Interfaces 2 comprise interfaces Al, which may be browsed by a personal computer (hereinafter referred to as a PC), and interfaces A2, which may be browsed by a mobile terminal or other similar device; the interfaces 2 are open to the network 5 and are constituted by web pages that can be browsed. The web pages of interfaces 2 have various registration buttons.

In addition, various sites 6 provide information registered at server 1 as web pages.

The present invention is realized by the general system, in which information posted on the web pages of interfaces 2 that are open to network 5 is not only in server 1, but also in a plurality of various sites 6 (S1-S4).

In said general system, a recruiting company accesses interfaces 2 through network 5, and registers information about the company, recruitment, courses, etc., according to a particular format.

Job-seekers and prospective applicants for certification get necessary information about recruiting, student applications, and other information at the specialized site for information about job offers and recruiting (server 1) and at sites 6, using the system for providing information about recruiting.

### Embodiment 1

The general system of the present invention, as mentioned above, is shown as FIG. 1.

First, the server 1 for the specialized site for information about job offers and recruiting has interfaces 2, control systems 3, and databases 4.

Interfaces 2 comprise interface A1, which may be browsed by a PC, interface A2, which may be browsed by a mobile terminal, PHS, PDA, etc., and web pages that may be browsed and that are open to Network 5. The web pages of interfaces 2 have a button for registering a company's information, a button for registering other information, a button for posting on other sites, a button for posting on server 1, a button for registering IDs, passwords, and e-mail addresses of job-seekers and prospective applicants for certification, and a button for applying and registering resumes and manuscripts of professional activities.

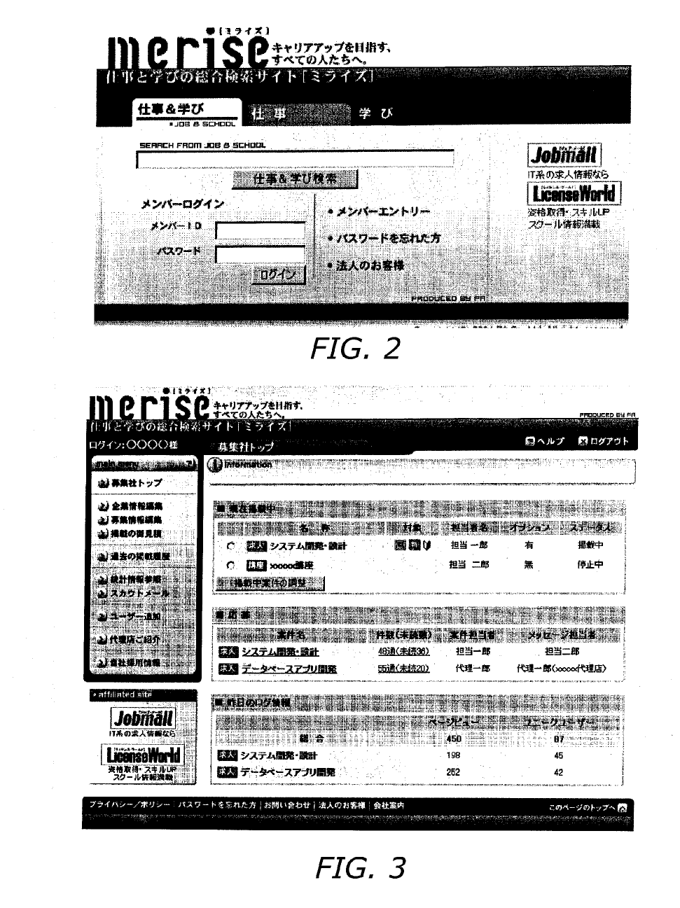

An example of the front page of the interface A1, which may be browsed by a PC, is shown as FIG. 2.

Control systems 3 comprise: a function control system B1 for job-seekers and prospective applicants for certification; a function control system B2 for recruiting companies; a control system B3 for providing information about recruitment, courses, seminars, mock examinations, etc., on various sites; a control system B4 for sales; a control system B5 for application points; a control system B6 for users' various histories; and a page generator B7 for various sites.

Databases 4 comprise: a database D1 of IDs, passwords, and e-mail addresses of job-seekers and prospective applicants for certification; a database D2 of resumes and professional vitae for, and information sought by, job-seekers/prospective applicants for certification; a database D3 of IDs, passwords, and e-mail addresses of recruiting companies; a database D4 of recruiting companies' information; a database D5 of information about recruitments and targeted information; a database D6 of seminar information and targeted information; a database D7 of users' various histories; a database D8 of sales; and a database D9 of application points.

Control systems 3 accept registration information relating to recruitment, courses, seminars, mock examinations, and other information and maintains it in databases 4; at the same time, the control systems 3 keep the information constantly updated and provides it to the interfaces 2 as a web page.

A recruiting company logs into the interface A1 via the network 5, and then “My Page” for the recruiting company appears.

An example of “My Page” for a recruiting company is shown as FIG. 3.

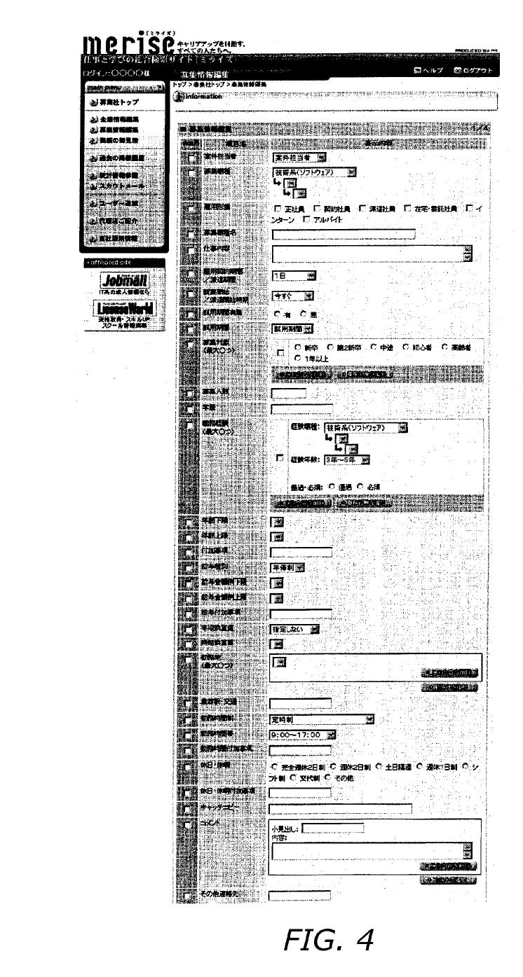

FIG. 4 shows an example of an “Edit Page” of recruiting information according to the format that appears after selecting the registration button at “My Page” for the recruiting company in FIG. 3. Information must be filled out under the format of FIG. 4, and “Display” or “Do Not Display” must be selected.

Next, a page generator for the various sites B7 of the control systems 3 automatically creates a file (File 1) dedicated to posting information regarding recruitment, courses, seminars, mock exams, etc., for those sites, saves it to the server 1, and then connects to the server 1 to automatically create a file (File 2) in which a program for providing information regarding recruitment, courses, seminars, mock exams, etc., is written.

When File 1 is used, it is by linking from the various sites 6 to the specialized site for information about job offers and recruiting; when File 2 is used, the file is informatively provided to the various sites.

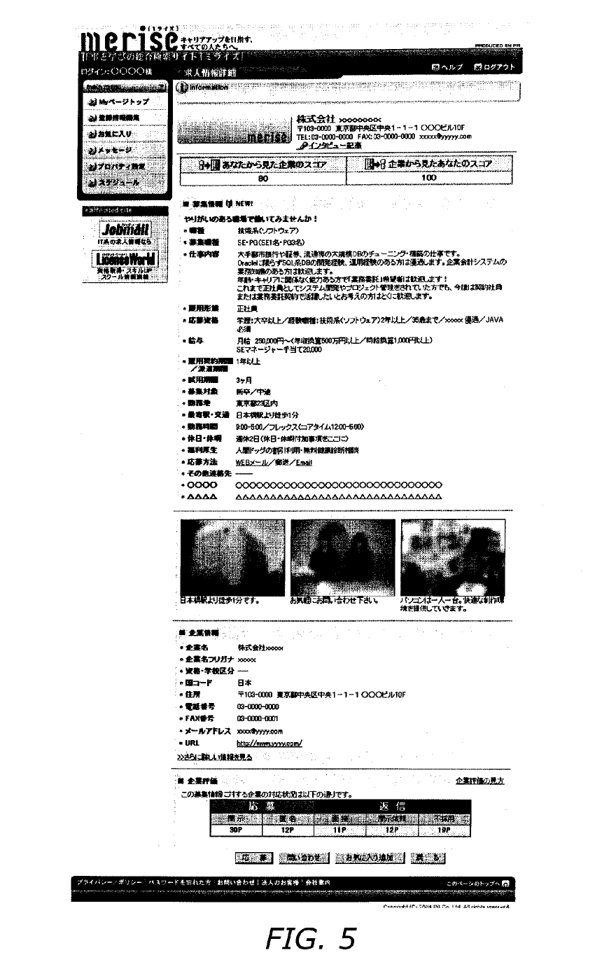

FIG. 5 shows an example of a display common to the specialized site for information about job offers and recruiting, and to the various other sites 6.

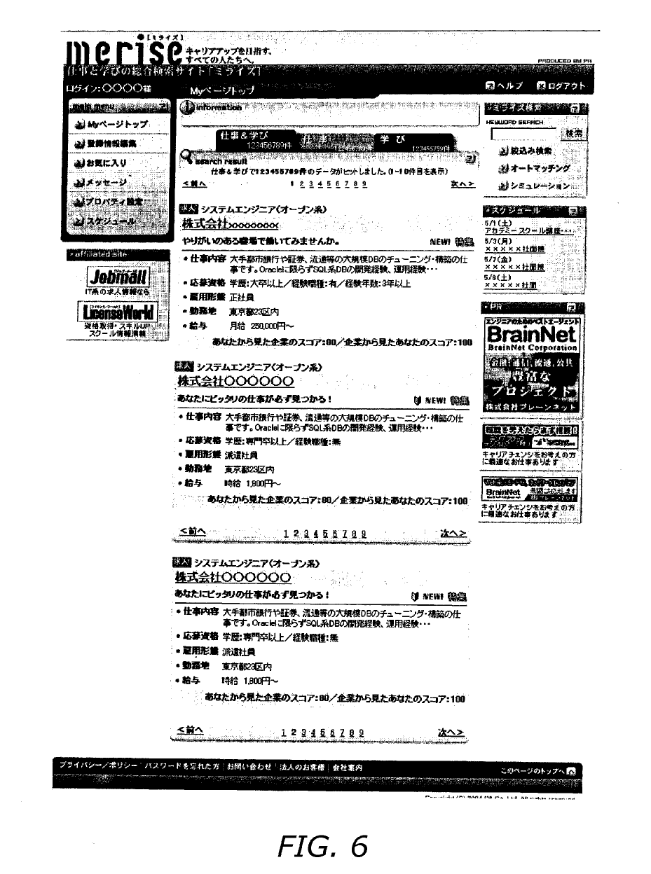

FIG. 6 shows an example of a “My Page” for job-seekers and prospective applicants for certification that appears after a login at the interface A1 of FIG. 2.

### Embodiment 2

Next, in Embodiment 2, the general system in Embodiment 1 is used. The recruiting company accesses the interfaces 2 via the network 5, selects information regarding recruitment, courses, seminars, mock examinations, etc., for posting, and clicks a button for posting the information on various sites located on the interfaces 2; a page generator for the various sites b7 automatically creates a file for posting the information on the sites, and saves the file to the server 1. The recruiting company links the file to the web page within its own site to display the file; selected information is displayed to the public, such as information about recruitment, courses, seminars, mock examinations, etc., while other selected information is hidden, such as information about IDs, passwords, resumes, and manuscripts of professional activities of job-seekers and prospective applicants for certification, in the same manner as it is displayed or hidden on the web page of the recruiting company's own site.

A specific example is as follows: For example, in the various sites 6, the URL of the recruiting company's own site S1 is http://www.123.jp, and the URL of the server 1 for the specialized site for information about job offers and recruiting is http://www.ABC.jp.

The above URLs are just examples and may be changed depending on acquired domains, services, and organization types.

(1) The recruiting company accesses the interfaces 2 via the network 5, registers information about recruitment, courses, seminars, mock examinations, etc., and selects information to be posted on its own site. Next, if there are any particular formats or templates designed for the recruiting company's own site, they are saved to the server 1.

(2) After a recruiting company clicks a button for posting on the various sites, the control system for providing information about recruitment, courses, seminars, mock examinations, etc., on the various sites B3 saves the information regarding the company's own site to the recruitment information and targeted information database D5, and to the seminar information and targeted information database D6. At the same time, a page generator for the various sites B7 connects to the recruitment information and targeted information database D5 and to the seminar information and targeted information database D6, calls up a template, saved on the server 1, uniquely designed and formatted for the recruiting company's own site, and automatically creates an HTML, etc. file uniquely designed and formatted for the recruiting company's own site and having, within the body text thereof, display items with the same information as that provided through the interfaces 2 of the server 1; and the page generator then saves the file with the URL displayed when the ID and password of the recruiting company are created on the server 1, such as http://www.ABC.jp/001/jisha.html.

If there is no particular template for a recruiting company's own site, standard templates saved on the server 1 are used to create a file automatically.

The recruiting company provides a link to http://www.ABC.jp/001/jisha.html to display information about recruitment, courses, seminars, mock examinations, etc., in the desired pages of its own site.

(3) A job seeker or prospective applicant for certification designates the URL of the recruiting company's own site S1, http://www.123.jp, clicks a button that provides information about recruitment, courses, seminars, mock examinations, etc., and then jumps to the designated link, http://www.ABC.jp/001/jisha.html (in server 1) that displays a web page with public information such as information about recruitment, courses, seminars, mock examinations, etc., and information hidden to other users, such as information about IDs, passwords, resumes, and manuscripts of professional activities of the job-seeker or prospective applicant for certification. The job seeker or prospective applicant for certification browses the web page without feeling connected to the server 1, as if he or she were browsing the recruiting company's own site.

### Embodiment 3

Next, in Embodiment 3, the general system of example 1 is used. The recruiting company accesses the interfaces 2 via the network 5, and selects information regarding recruitment, courses, seminars, mock examinations, etc., for posting, clicks a button for posting the information on various sites located in the interfaces 2 to connect to server 1, which automatically creates a file for a program to provide information regarding recruitment, courses, seminars, mock examinations, etc., by means of a page generator for various sites B7. The recruiting company saves the file to the desired web page for providing information about recruitment, courses, seminars, mock examinations, etc., within its own site, which displays public information such as information about recruitment, courses, seminars, mock examinations, etc., while hiding other information such as information about IDs and passwords of the recruiting company' and information about IDs, passwords, resumes, and manuscripts of professional activities of job-seekers and prospective applicants for certification, etc., in the same manner as it is displayed or hidden on the web page of the company's own site.

A specific example is as follows: For example, in the various sites 6, the URL of a recruiting company's own site S1 is http://www.123.jp, and the URL of the server 1 for the specialized site for information about job offers and recruiting is http://www.ABC.jp.

The above URLs are just examples and may be changed depending on acquired domains, services, and organization types.

(1) The recruiting company accesses the interfaces 2 via the network 5, registers information about recruitment, courses, seminars, mock examinations, etc., and selects information to be posted on its own site. Next, if there are any particular formats or templates designed for the recruiting company's own site, they are saved to the server 1.

(2) After a recruiting company clicks a button for posting on the various sites, the control system for providing information about recruitment, courses, seminars, mock examinations, etc., on the various sites B3 saves the information regarding the company's own site to a database of information about recruitments and targets D5 and to a database of information about seminars and targets D6. At the same time, a page generator for the various sites B7 connects to a database of information about recruitments and targets D5 and to a database of information about seminars and targets D6 and creates a particular format or a template designed for the recruiting company's own site, saved on the server 1, and automatically creates a file that is written as a program to operate a URL connected to the server 1 and the control system of the server 1, more specifically, http://www.ABC.jp/F?K001=123/, as an example, according to the format and design of its own site as written in HTML, etc.

If there is no particular template for a recruiting company's own site, standard templates saved on the server 1 are used to create a file automatically.

The recruiting company provides a link to a desired web page of its own site, such as http://www.123.jp/kyujin.html to display information about recruitment, courses, seminars, mock examinations, etc., in the desired pages of its own site.

(3) When a job seeker or prospective applicant for certification clicks a button that designates the http://www.123.jp/kyujin.html URL, a page opens, and at the same time the program, written in the body text in HTML of that page, operates the control systems 3, http://www.ABC.jp/F?K001=123/. The program connects to the server 1, and at the same time operates the control system for providing information about recruitment, courses, seminars, mock examinations, etc. to the various sites B3 of the control systems 3 of server 1; the program then connects to the database of information about recruitments and targets D5 and to the database of information about seminars and targets D6, and displays information about recruitment, courses, seminars, mock examinations, etc., that is designated as public information, displaying it as the same information as that provided from the interfaces 2 of the server 1 in HTML at the page of http://www.123.jp/kyujin.html.

There are a variety of means of connecting to the server 1 and providing information, such as cgi, jsp, asp, HTML, XML, ActiveX, Java (registered trademark) applet, and Flash.

(4) In the site 6, in addition to public information that the recruiting company selects to post on its own site, hidden information limited by IDs, passwords, etc., is displayed at the page of http://www.123.jp/kyujin.html.

### Embodiment 4

Next, in Embodiment 4, the general system in example 1 is used. The recruiting company can access the interfaces 2 via the network 5 and register information regarding recruitment, courses, seminars, mock examinations, etc., or other information for posting. After the recruiting company selects information for posting on its own site and clicks a button for posting on various other sites, the page generator for the various sites B7 operates to automatically create a file (File 1) for posting information regarding recruitment, courses, seminars, mock examinations, etc., of that particular recruiting company and saves it to the server 1. The page generator connects to the server 1 to automatically create a file (File 2) for a program to provide information regarding recruitment, courses, seminars, mock examinations, etc. If the recruiting company uses the File 1, the file is linked from its own site; if the recruiting company uses the File 2, the file is saved in the company's own site to provide information to both the server 1 and the various sites 6, or to either one of them.

The process is as follows: (1) The recruiting company accesses the interface A1, which may be browsed by a PC, and interface A2, which may be browsed by the mobile terminal of the interfaces 2 through the network 5 with a PCF, and clicks the “For Corporate Client” button. Next, the function control system B2 for recruiting companies operates, and the “Membership Form Page” opens. On this page, the recruiting company enters the company's and administrator's data, and clicks the registration button for the company's information to operate the control system for functions relating to recruiting companies B2. The data are then saved to the database of IDs, Passwords, and e-mail addresses of recruiting companies D3, and to the database of recruiting companies' information D4, IDs and passwords are created for each company, and “My Page” is registered. Also, the URL linked to a later-described file (File 1) for providing information about recruitment, courses, seminars, mock examinations, etc., of the particular recruiting company is displayed. The URL linked to the file may be displayed after File 1 and File 2 are created.

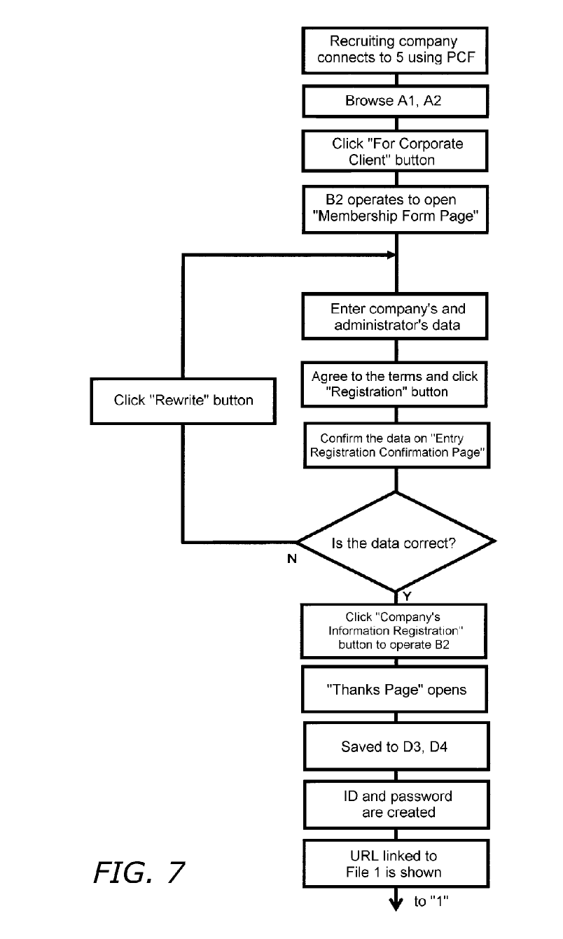

The above procedures are shown on the flowchart for registration of the recruiting company in FIG. 7.

(2) The recruiting company enters its ID and password at the interface A1, which may be browsed by PC, and at the interface A2, which may be browsed by a mobile terminal, and clicks the login button. “My Page” then opens. Next, the recruiting company enters information about recruitment, courses, seminars, mock examinations, etc., and clicks the registration button for various information to operate the control system for functions relating to recruiting companies B2 so that the data are saved to the database of information about recruitments and targets D5 and to the database of information about seminars and targets D6.

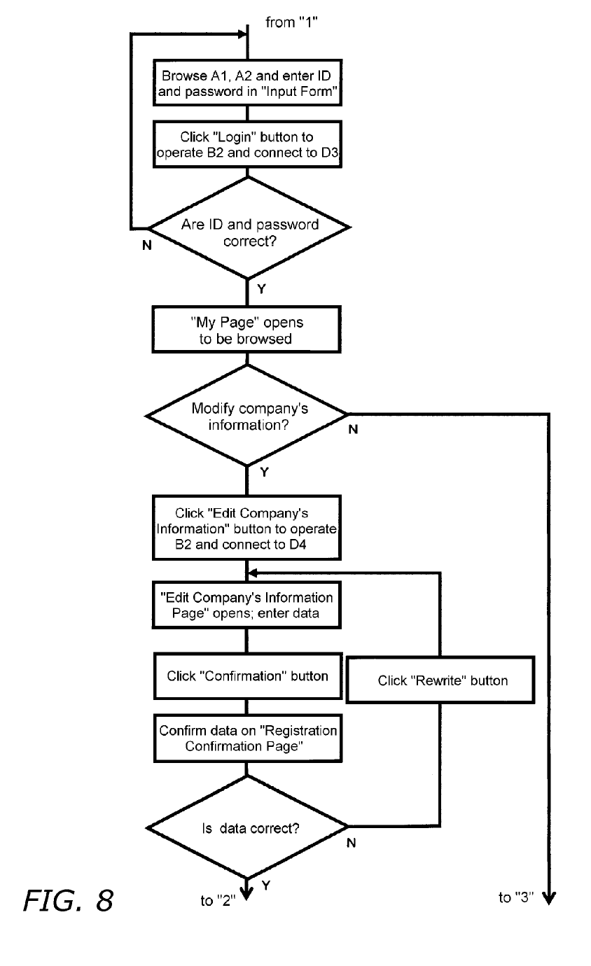

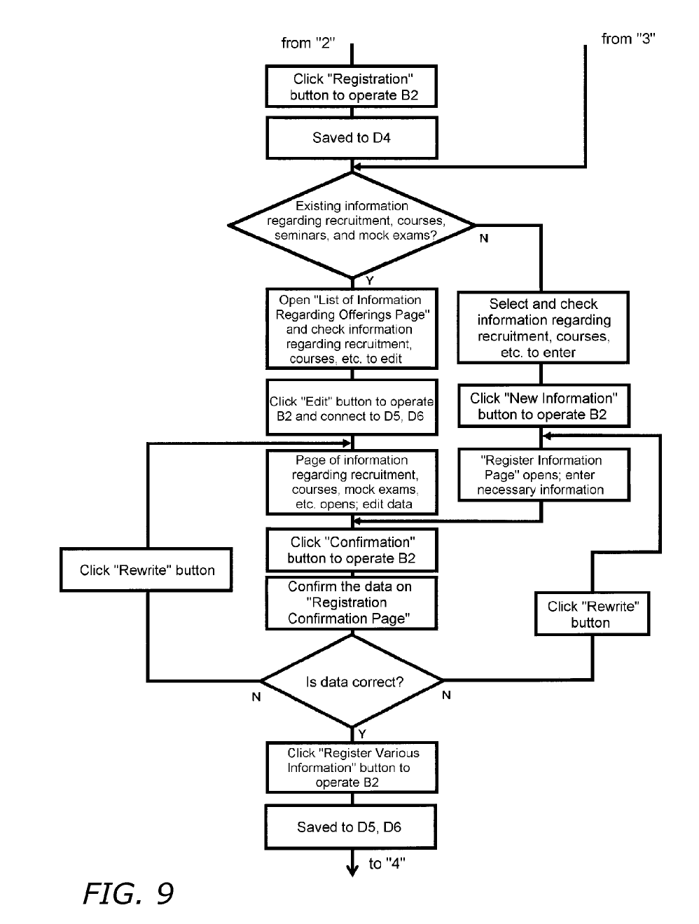

The above procedures performed by the recruiting company are shown on the flowchart for registration of information about recruitment, courses, seminars, and mock examination in FIG. 8 and FIG. 9.

(3) When providing information at its own site, the recruiting company selects information about recruitment, courses, seminars, mock examinations, etc. for posting on its own site at the above-mentioned “My Page,” and selects the “Posting on Own Site in Purchase Window.”

Next, if there are any particular formats or designed pages, they are saved to the server 1. The unique page for the recruiting company's own site may be created not only by the company, but also by a professional designer.

The recruiting company then clicks the “Posting at Various Sites” button to operate the control system for providing information about recruitment, courses, seminars, mock examinations, etc. to the various sites B3, and the data are saved to the database of information about recruitments and targets D5 and to the database of information about seminars and targets D6. At the same time, the page generator for the various sites B7 operates to automatically create a file (File 1) for posting information regarding recruitment, courses, seminars, mock exams, etc., that is unique to the recruiting company, and saves it to the server 1. It also connects to the server 1 to automatically create a file (File 2) in which a program of providing information regarding recruitment, courses, seminars, mock exams, etc. is written.

If the File 1 is used, the URL linked to the File 1 that was displayed when the ID and password of the recruiting company were created is linked to display the information on the desired page of the recruiting company's own site. If the File 2 is used, the page is downloaded to be saved to the server of the recruiting company's own site.

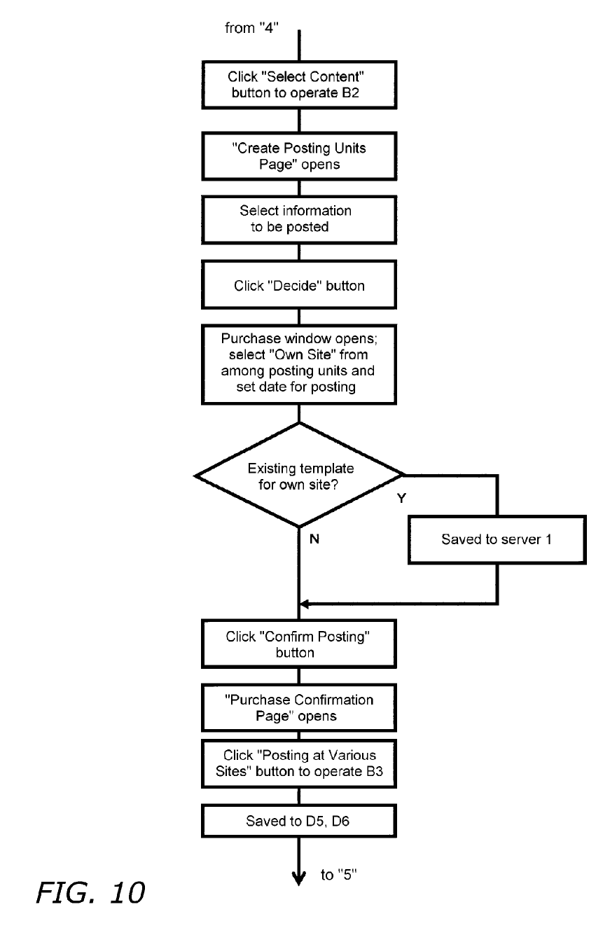

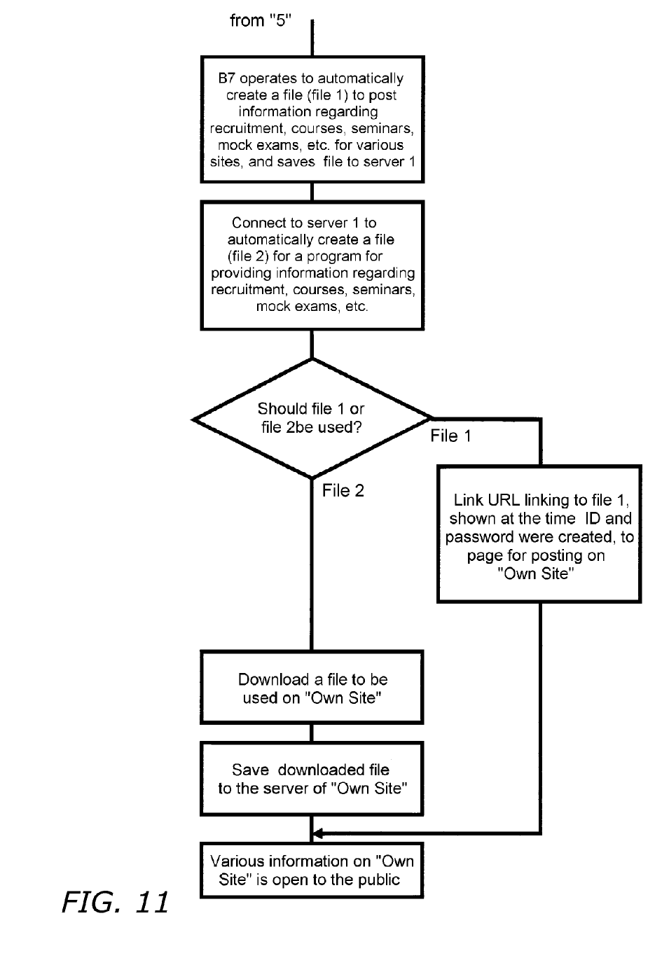

The above procedures are shown at the flowchart for posting on the recruiting company's own site in FIG. 10 and FIG. 11.

(4) When providing information at the server 1, the recruiting company selects information for posting on the server 1 at the above-mentioned “My Page,” selects “Post Ad through Purchase Window,” and clicks the “Post on Server” 1 button to operate the control system for functions relating to recruiting companies B2; the data are then saved to the database of information about recruitments and targets D5 and to the database of information about seminars and targets D6, so that the information may be provided at the interfaces 2.

As for the rate for providing information, the rate is dependant on the posting period, while the fee is dependent on the number of applications; both are reasonable. In addition, a discount for providing information on the server 1 is available, with application points being gained by posting information about recruitment, courses, seminars, and mock examinations on the recruiting company's own site. Points for recruiting companies are saved in the database of application points D9, and a discount per point is given.

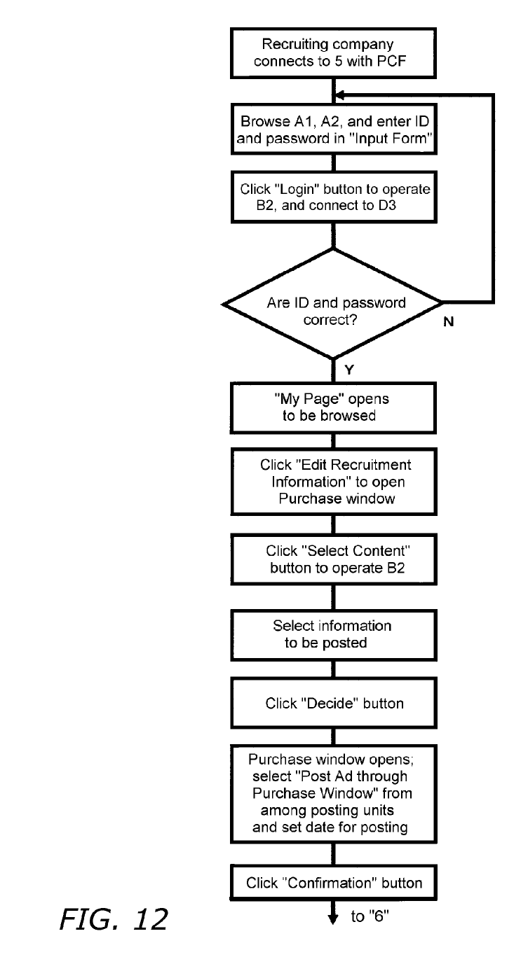

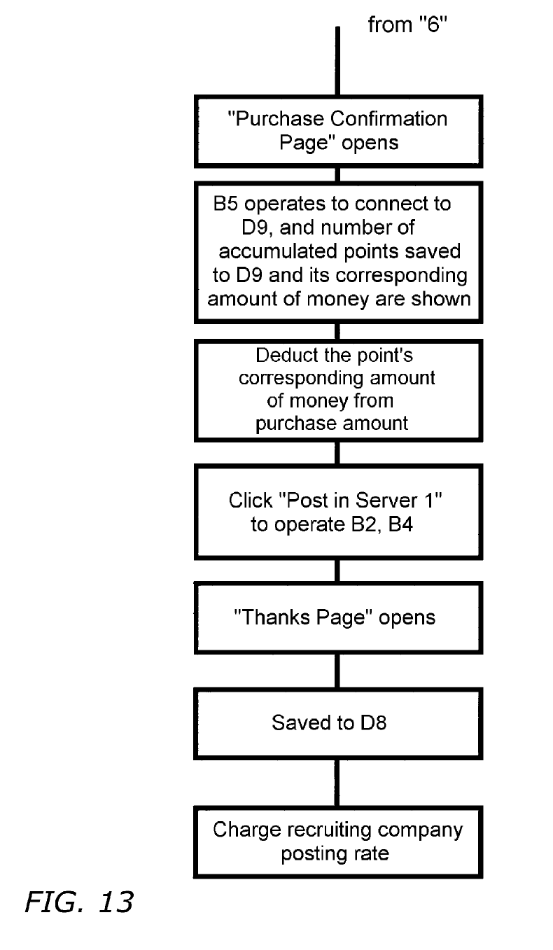

The above procedures are shown at the flowchart for posting rates in FIG. 12 and FIG. 13.

### Embodiment 5

In Embodiment 5, the general system of example 1 is used. Job-seekers and prospective applicants for certification can get the necessary information about recruitment, courses, seminars, mock examinations, etc., at the various sites 6, and by clicking a button for applying and registering resumes and manuscripts of professional activities via the various sites 6, control systems 3 for functions related to job-seekers and prospective applicants for certification B1 receives the resumes and manuscripts of professional activities and saves them to the database of resume, manuscripts of professional activities, and targets of job-seekers and prospective applicants for certification D2 of the databases 4. It also saves them to the database of users' various histories D7 or delivers them by e-mail through the network 5.

The process is as follows: (1) Job-seekers and prospective applicants for certification access the various sites 6 via the network 5 with PCA-D, and select a featured section for information about recruitment, courses, seminars, and mock examinations. If the above-mentioned File 1 is used for the recruiting company's featured section, the page jumps to the server 1, and displays information about recruitment, courses, seminars, and mock examinations. Job-seekers and prospective applicants for certification browse the information and click a button for applying and registering resumes and manuscripts of professional activities if they want to apply for or request a brochure of the information, which operates the control system for functions relating to job-seekers and prospective applicants for certification. If the File 2 is used for the recruiting company's featured section, the control system for providing information about recruitment, courses, seminars, mock examinations, etc., to the various sites B3 operates and displays information about recruitment, courses, seminars, mock examinations, etc. Job-seekers and prospective applicants for certification browse the information and click a button for applying and registering resumes and manuscripts of professional activities to jump to the server 1 if they want to apply for or request a brochure of the information. The control system for functions relating to job-seekers and prospective applicants for certification B1 then operates.

(2) Next, a login page opens. The job seeker or prospective applicant for certification enters the desired ID, password and e-mail address, and clicks a button for registering the ID, password, and e-mail address to save them to the database of IDs, passwords, and e-mail addresses of job-seekers and prospective applicants for certification D1.

Subsequently, an application form opens. The job seeker or prospective applicant enters the necessary information on the form, and clicks a button for applying and registering resumes and manuscripts of professional activities to operate the control system for functions relating to job-seekers and prospective applicants for certification B1, which saves the information to the database of resumes, manuscripts of professional activities, and targets of job-seekers and prospective applicants for certification D2; at the same time, the control system for users' various histories B6 is operated, which saves the information to the database of users' various histories D7 or sends the resume or manuscript of professional activities by e-mail. In addition, the control system for application points B5 operates, adding points and saving them as the recruiting company's points to the database of application points D9.

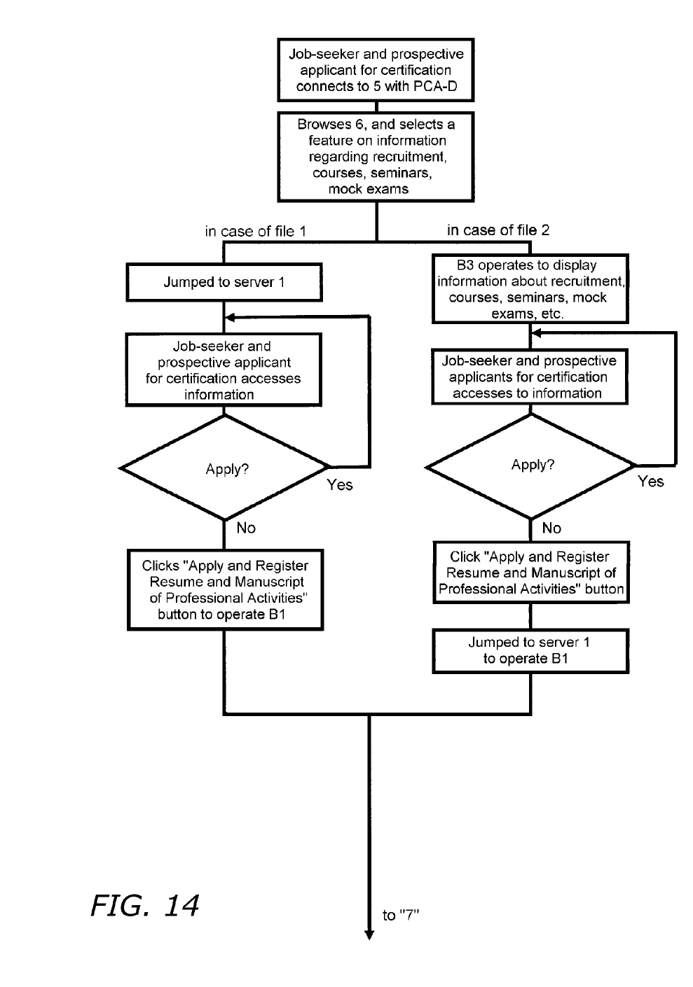

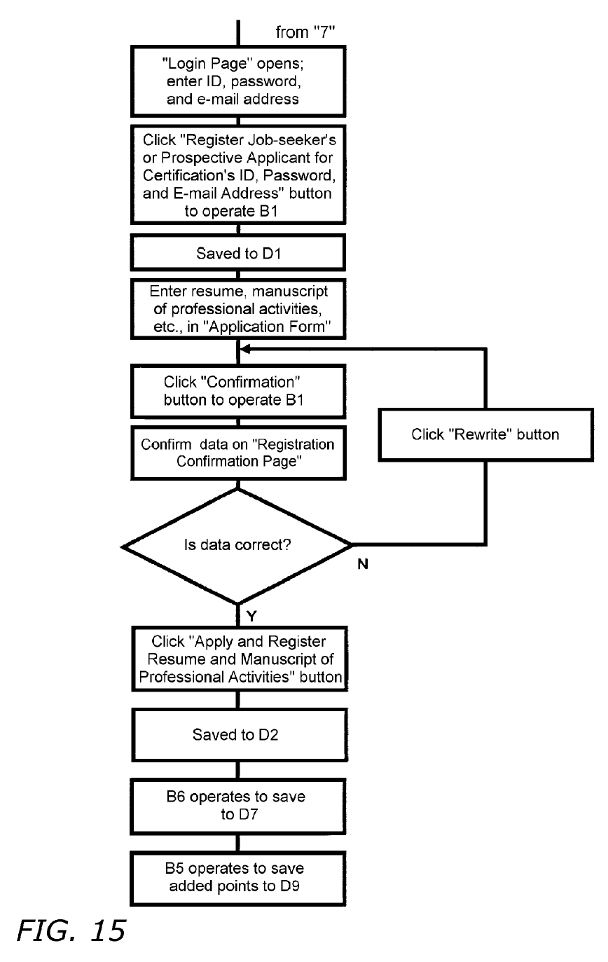

The above procedures are shown at the flowchart for registration and applications of job-seekers and prospective applicants for certification in FIG. 14 and FIG. 15.

As mentioned above, the present invention achieves the following advantages by setting up web pages as the interfaces 2 open to the network 5 not only in the server 1 of the specialized site for information about job offers and recruiting, but also in a plurality of various other sites 6 (S1-S4). (1) Much more information can be transmitted than the amount that can be transmitted solely only on the web pages of the server 1 of the specialized site for information about job offers and recruiting, and much more data relating to job-seekers and prospective applicants for certification can be collected and saved to the database. (2) The frequency of browsing the web pages is higher because the various linked sites 6 (S1-S4) also have user-appealing feature sections. Accordingly, with this general system, (3) recruiting companies can provide information about recruiting to targeted job-seekers and potential job-seekers, and schools can provide information about the application process to desired prospective applicants for certification. The system also enables the companies to be introduced with greater certainty to personnel they wish to employ, and by the system carrying out notifications in order to secure the necessary number of applications, the likelihood of hiring is raised. Furthermore, by the system making announcements to secure a number of requests for brochures and other materials on a school from persons who wish to enter the school, the likelihood of new entrants to the school is raised. (4) Job-seekers and prospective applicants for certification can gain recruiting and other information by accessing both the server of the specialized site for information about job offers and recruiting and a number of other sites, and in the same manner, can apply for employment or request a brochure from the recruiting company whenever they want. In addition, (5) recruiting companies can more easily manage and update web pages, and (6) the mobilization of human resources through the network is promoted.

The present invention can be used for the various applications as described above.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

1. A specialized system employing an aggregate system to provide information on positions/help wanted, the specialized system comprising:
a plurality of nonspecific sites linked via a network;
a server, connected to the network, for hosting a dedicated site devoted to positions-wanted and help-wanted information, said server including
dedicated-site interfaces for carrying positions-wanted and help-wanted information, said dedicated-site interfaces open to the network and browsable by stationary and mobile communications devices,
databases, and
control systems operating in association with said databases, for providing positions-wanted and help-wanted information to said server to be carried on said dedicated-site interfaces, and for posting said positions-wanted and help-wanted information as carried on said dedicated-site interfaces to numerous locations on said nonspecific sites, whereby said nonspecific sites are provided the same information as that on said server.

2. A system of providing information about job offers and recruiting through a general system, comprising a server for the specialized site for information about job offers and recruiting connected to network, and various sites connected to network, in which the server has interface, control system, and database, in which the interface is open to the network, and comprised of interface browsable by personal computer, mobile terminal, etc.,
in which the interface posts necessary information about job offers and recruiting, improving career and skill, etc. with a button for registering e-mail delivery, a button for applying and registering resume and manuscript of professional activities, etc.,
in which the control system is comprised of a control system for function to job-seekers/prospective applicants for certification, a control system for function to recruiting companies, a control system for users' various histories, a control system for providing information about recruitment, course, seminar, mock examination, etc. to the own site, a control system for sales, a control system for application points, a control system for e-mail delivering, etc.,
in which the database is comprised of a database of ID, password, e-mail address of job-seekers/prospective applicants for certification, a database of resume, manuscript of professional activities, targets of job-seekers/prospective applicants for certification, a database of ID, password, e-mail address of recruiting companies, a database of recruiting companies' information, a database of information about recruitments and targets, a database of information about seminars and targets, a database of users' various histories, a database of sales, a database of application points, etc.,
in which said control system keeps information of recruiting companies, courses, etc. updated constantly, and provides them to interface through database,
and in which various sites are provided the same information as the server provides, by the control system for providing information about recruitment, course, seminar, mock examination, etc. to various sites of said control system posting information posted at the interface of the server,
in which information posted in the interface of the specialized site for information about job offers and recruiting is not only in the specialized site for information about job offers and recruiting, but also in plurality of various sites.

3. In claim 1, a system of providing information about job offers and recruiting through a general system is characterized in that information posted at the interface is registrable by selecting and entering desired information to be posted for various sites according to a format at the specialized site for information about job offers and recruiting, in which information posted in the interface of the specialized site for information about job offers and recruiting is not only in the specialized site for information about job offers and recruiting, but also in plurality of various sites.

4. In claim 2, a system of providing information about job offers and recruiting through a general system is characterized in that information posted at the interface is registrable by selecting and entering desired information to be posted for various sites according to a format at the specialized site for information about job offers and recruiting, in which information posted in the interface of the specialized site for information about job offers and recruiting is not only in the specialized site for information about job offers and recruiting, but also in plurality of various sites.

5. A system of providing information about job offers and recruiting through a general system, comprising a server for the specialized site for information about job offers and recruiting connected to network, and various sites connected to network, in which the server has interface, control system, and database, in which the interface is open to the network, and comprised of interface browsable by personal computer, mobile terminal, etc.,
and in which various sites access to the specialized site for information about job offers and recruiting, and enter desired information to be posted for various sites by selecting information according to a format at the specialized site for information about job offers and recruiting to register the information at the specialized site for information about job offers and recruiting, and also by providing links to the corresponding registered information of the specialized site for information about job offers and recruiting in HTML documents making up website of various sites,
information posted in the interface of the specialized site for information about job offers and recruiting is not only in the specialized site for information about job offers and recruiting, but also in plurality of various sites.

6. A system of providing information about job offers and recruiting through a general system, comprising a server for the specialized site for information about job offers and recruiting connected to network, and various sites connected to network, in which the server has interface, control system, and database, in which the interface is open to the network, and comprised of interface browsable by personal computer, mobile terminal, etc., and in which various sites access to the specialized site for information about job offers and recruiting, and enter desired information to be posted for various sites by selecting information according to a format at the specialized site for information about job offers and recruiting to register the information at the specialized site for information about job offers and recruiting, and also by saving the same information to various sites so as to display the corresponding registered information at the webpage of various sites as well, information posted in the interface of the specialized site for information about job offers and recruiting is not only in the specialized site for information about job offers and recruiting, but also in plurality of various sites.
